(19) United States
(12) Patent Application Publication
(10) Pub. No.: US 2016/0113020 A1
(43) Pub. Date: Apr. 21, 2016

(54) ADDITIONAL ASSISTANCE INFORMATION FOR COMMON REFERENCE SIGNAL INTERFERENCE

(71) Applicants: Lili Zhang, Beijing (CN); Chunyan Gao, Beijing (CN); Haiming Wang, Beijing (CN); Jing Han, Beijing (CN); Wei Hong, Beijing (CN)

(72) Inventors: Lili Zhang, Beijing (CN); Chunyan Gao, Beijing (CN); Haiming Wang, Beijing (CN); Jing Han, Beijing (CN); Wei Hong, Beijing (CN)

(21) Appl. No.: 14/777,674

(22) PCT Filed: Apr. 1, 2013
(86) PCT No.: PCT/CN13/00379

§ 371 Date: Sep. 16, 2015

(51) Int. Cl. H04W 72/08; H04W 72/04; H04W 16/32

(52) U.S. Cl. CPC H04W 72/082; H04W 16/32; H04W 72/0426; H04W 72/0473; H04W 72/042

(57) ABSTRACT

Embodiments of the invention provide a method, apparatus and computer readable memory for operating a network access node. The method begins by coordinating uplink/downlink subframe configurations between a serving network access node and a neighbor network access node. The method continues with receiving at the serving network access node from the neighbor network access node an indication of transmit power used by the neighbor access node for at least one downlink subframe of the neighbor access node's uplink/downlink subframe configuration and sending the indication of transmit power from the serving network access node to a user equipment served by the serving network access node.

### TECHNICAL FIELD

The exemplary and non-limiting embodiments of this invention relate generally to wireless communication systems, methods, devices and computer readable memories and, more specifically, relates to common reference signal (CRS) interference cancellation in a cell.

### BACKGROUND

Same frame timing and same uplink (UL)-downlink (DL) configurations are deployed practically throughout the entire network and in time division duplex (TDD) deployments in Long-Term Evolution (LTE) Release 2011 or earlier. These deployments avoid interference between UL and DL transmissions including base station-to-base station signals and user equipment (UE)-to-UE interference. However, since the DL/UL configurations of a particular local area (LA) cell in a LA network may not match the traffic situation in different LA cells with a small number of users, it is desirable to make the DL-UL configuration more dynamic to adapt to the traffic status in each cell.

There have been a number of proposals that attempt to manipulate the UL-DL configurations between wireless entities in order to allow for better communication signaling between. The Center for Advanced Technology in Telecommunications (CATT) in document RP-121722 has proposed a new work item for Release 2012 on eIMTA. This proposal was meant to find a solution which enables TDD UL-DL reconfiguration in order to adapt to traffic variations, improve resource efficiency, and power saving or traffic delay. Another proposal can be found in document TR 36.828, which mentions four different time scales for TDD DL-UL reconfiguration. The different time scales proposed provide different gains from different types of traffic adaptations. However, even though there are potential gains from TDD DL-UL reconfigurations, the reconfigurations also create problems, which include: (1) signaling mechanism(s) for TDD UL-DL reconfiguration, (2) hybrid automatic repeat request (HARQ) timing in case of DL-UL reconfiguration, and (3) DL-UL interference handling.

Moreover, in a heterogeneous network deployment, enhanced inter-cell interference coordination (eICIC) in a time domain is effective in improving the system and cell-edge throughput. An example of a heterogeneous network is an LTE network wherein a number of smaller cells are in the coverage area of a larger macro cell. Traffic between the macro cell and the UEs it serves can be offloaded to the smaller cells to create better efficiency in the network. In this example, with eICIC, a macro cell utilizes almost blank subframes (ABS) with zero transmission power mainly in the physical control channel (PDCCH)/physical downlink shared channel (PDSCH) to mitigate interference to the small (pico) cell UEs with cell range expansion (CRE). Transmission power in an ABS is not always truly zero; those familiar with the term as currently understood will recognize that the blanked cell is allowed to transmit certain specified transmissions such as synchronization and reference signals while still maintaining the subframe as an ABS.

In order to further the ability for UL-DL configurations in a cell wherein there is signal interference between base stations and UEs, the following has been agreed upon in document R1-106551 by TWG RAN WG1 entitled, “LS on CSI measurements on restricted subframes for eICIC” [3GPP TSG RAN WG1 #63; Jacksonville, Fla., US; 15-19 Nov. 2012]: (1) one neighboring measurement subset is defined, (2) one serving cell measurement subset is defined, and (3) channel state information (CSI) (for example channel quality information (CQI), pre-matrix coding information (PMI), and rank indicator (RI)) feedback based on interference measurements in restricted subsets of subframes is enabled through configured subsets of subframes indicated by CSI measurement subframe configurations. The subframe subsets will be signaled by the radio resource controller (RRC), with for example, bitmaps of size matching the size of almost blank subframe patterns. The 0 or 2 subframe subsets can be configured for each UE. The baseline occurs when the UE only reports CSI for each configured subframe subset. If 0 subframe subsets are configured then the proposal in document R1-106551 is inapplicable. The 2 subframe subsets may or may not be the complement of each other.

Based on the above measurement subset, there has been extensive discussion on CRS interference handling in ABS based time domain enhanced inter-cell interference coordination (eICIC) solutions. Document R1-121901 by LG Electronics entitled “LS on feICIC” [3GPP TSG-RAN1 #68bis; Jeju, Korea; 26-30 Mar. 2013], concluded that the serving cell via higher layer signaling can provide: (1) parameters for each cell in the list of cell IDs; (2) the number of CRS ports; (3) the subframes containing CRS, such as multicast-broadcast signal frequency network (MBSFN) configuration; and (4) for further study (FFS) for additional information, such as ABS patterns. For example, this may be provided in CSI reporting, demodulation, radio link monitoring (RLM), or radio resource management (RRM) for further enhanced inter-cell interference coordination (feICIC) capable UEs for the purpose of CRS interference handling from neighboring cells with ABS configuration.

Document 3GPP TS 36.331 v11.3.0 (2013 March) provides a baseline for CRS interference cancellation, but it does not take into account the above mentioned problems. An example of document 3GPP TS 36.331 v11.3.0 (2013 March) can be seen in FIG. 1.

### SUMMARY

In a first exemplary aspect of the invention there is a method for operating a network access node. The method comprises coordinating uplink/downlink subframe configurations between a serving network access node and a neighbor network access node. The method further comprises receiving at the serving network access node from the neighbor network access node an indication of transmit power used by the neighbor access node for at least one downlink subframe of the neighbor access node's uplink/downlink subframe configuration and sending the indication of transmit power from the serving network access node to a user equipment served by the serving network access node.

In a second exemplary aspect of the invention there is an apparatus. The apparatus comprises at least one processor, and at least one memory including computer program code. The at least one processor, with the at least one memory and the computer program code, being configured to cause the apparatus at least to coordinate uplink/downlink subframe configurations between a serving network access node and a neighbor network access node. The at least one processor, with the at least one memory and the computer program code are configured to further cause the apparatus at least to receive at the serving network access node from the neighbor network access node an indication of transmit power used by the neighbor access node for at least one downlink subframe of the neighbor access node's uplink/downlink subframe configuration and send the indication of transmit power from the serving network access node to a user equipment served by the serving network access node.

In a third exemplary aspect of the invention there is a computer readable memory tangibly storing a set of computer instructions comprising code. In this aspect when the code is executed on a data processing system it causes the data processing system to at least coordinate uplink/downlink subframe configurations between a serving network access node and a neighbor network access node. In this aspect when the code is executed on the data processing system it causes the data processing system to further receive at the serving network access node from the neighbor network access node an indication of transmit power used by the neighbor access node for at least one downlink subframe of the neighbor access node's uplink/downlink subframe configuration and send the indication of transmit power from the serving network access node to a user equipment served by the serving network access node.

These and other aspects are detailed below with more particularity.

### BRIEF DESCRIPTION OF THE DRAWINGS

FIG. 1 is prior art table from 3GPP TS 36.331 v 11.3.0 showing what information is included with CRS assistance information.

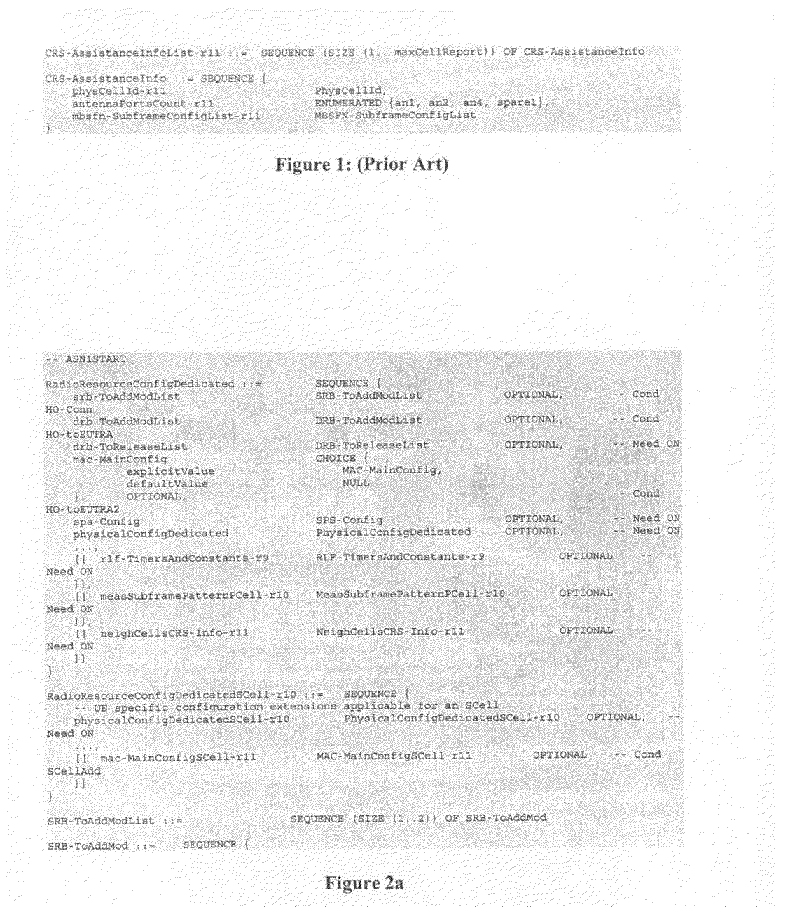

FIG. 2a and FIG. 2b are a continuous table illustrating a new RadioResourceConfigDedicated information element in accordance with exemplary embodiments of this invention.

FIG. 3 is a chart showing field descriptions of the fields within the RadioResourceConfigDedicated information element shown at FIG. 2a-b.

FIG. 4 is a logic flow diagram that illustrates the operation of a method, a result of execution by an apparatus, and execution of computer instructions comprising code embodied on a computer readable memory, in accordance with the exemplary embodiments of this invention.

FIG. 5 is a simplified block diagram of a UE in communication with two Access Nodes illustrating exemplary electronic devices suitable for use in practicing the exemplary embodiments of this invention.

### DETAILED DESCRIPTION

The examples detailed herein are in the context of an access node and a UE operating in a LA network with multiple densely distributed small cells. These examples are only to provide a practical context for describing the inventive concepts detailed herein; these teachings may be utilized with different network configurations which may still require cancellation of cell interference, without departing from the principles set forth herein.

Interference between UL-DL in a cell can be created in a number of instances. For example, a macro serving cell with many small cells and multiple UEs in its coverage area in an LTE network can create interference with each other depending on whether the access nodes or the UEs are operating on the UL or DL in a particular subframe of a radio frame. With the introduction of independent DL-UL reconfiguration in each cell and considering backward compatible issues, it can be assumed each cell adopts a TDD DL-UL configuration which can only be selected from the seven TDD configuration patterns specified in 3GPP TS 36.211 v 11.2.0 (2013 March) and 3GPP TS 36.321 11.2.20 (2013 March). Accordingly, in subframes 0, 1, 2, and 5 there is only DL-DL or UL-UL interference between a UE and an access node, since these subframes have a fixed link direction in any TDD configurations according to the above sever TDD configuration patterns. For other subframes, their link direction depends on the DL-UL configuration adopted. There can be UL-DL or opposite link interference depending on the TDD configuration adopted in neighboring cells. Here, subframes 0, 1, 2, and 5 which have fixed link direction are referred to as subframe type 1, while other subframes are referred to as subframe type 2. Due to different types of interference as well the interference from subframes type 1 and type 2, the transmission power at a DL power adjusted enhanced node-B (eNB) could be varied across these subframe types to satisfy the required signal to interference plus noise ratio (SINR).

One example of UL-DL cell interference occurs when a femto cell is within the coverage of macro cell. Since the femto cell may perform DL power control with the reference power changing correspondingly, a UE in the coverage area of the macro cell should take this into account for the involved ABS in order to provide the appropriate CRS interference cancellation.

Another example of UL-DL cell interference occurs when both a pico cell and a femto cell are located under the coverage of a macro cell. The femto cell is located at the edge of the pico cell with overlapping coverage. Due to the overlapping coverage, the pico cell and femto cell are interfering with each other, possibly severely. Additionally, flexible TDD is enabled at both the pico cell and the femto cell. This arrangement is referred to as a fixed subframe, when both the pico and the femto cells are in consistent DL operation with the macro cell. When both the pico cell and the femto cell are in a DL operation while the macro cell is in an UL operation due to flexible TDD, this is referred to as a flexible subframe. There are different interference situations in both types of subframes, which cause the femto cell eNB to set different transmission powers with a specific SINR target to be satisfied. A macro UE needs to account for PDSCH and CRS when they are set as ABS since both involves transmission power adjustment to determine the appropriate CRS interference cancellation.

To better address the above situations these teachings provide an enhancement of CRS interference cancellation which is particularly suitable for use in a dense LA network with flexible TDD enabled. Exemplary embodiments give some considerations on the insufficiency of current CRS interference cancellation when flexible TDD is enabled in a LA network, and furthermore provide for the appropriate enhancement to ensure the correct CRS interference cancellation in a dense LA network with flexible TDD. In short, the exemplary embodiments below provide for additional CRS interference cancellation information to be introduced with respect to different transmission power and the applied subframes in the defined ABS. This can be applied, for example during instances that a small cell is able to adjust its transmit power for sending reference signals.

A first exemplary embodiment can be utilized when a LA network with multiple densely distributed small cells, such as pico cells or femto cells, are overlapping and where flexible TDD is enabled for them. In this scenario, an access node such as an eNB transmits an indication of reference signal transmission power over an inter-eNB interface and transmits an indication of the neighboring cell reference signal transmission power to the serving UE. The femto cell eNB shall signal its reference signal transmission power to the macro eNB. The macro eNB transmits an indication of the neighbor cell (which is the femto cell eNB in this example) reference signal transmission power to the macro UE, so that a victim UE, in other words the UE operating in the macro cell in the coverage region of an aggressor neighbor cell may cancel the reference signal interference correctly in case of femto downlink power.

Another exemplary embodiment includes indicating the applicable flexible subframe set and fixed subframe set together with the corresponding reference transmission power so the UE can more easily apply the correct CRS interference handling/cancellation when it performs its measurement/CSI reporting. As an example for this embodiment, a UE is operating in a pico cell, which is also in the coverage region of an overlapping femto cell and both these cells are using a flexible TDD.

It is important to differentiate between a flexible TDD DL and the normal DL (that is in macro DL also) since they suffer from different interference and because the femto cell can set a different transmission power in the different subframe sets with respect to the SINR target that needs to be satisfied. The reference signal transmission power for a cell is divided into subframe specific. There is a different reference signal transmission power for different subframe sets. For example a flexible subframe set and a fixed subframe set will have different reference signal transmission powers.

Next, the femto cell eNB signals the different subframe sets, such as the flexible subframe set and fixed subframe set, together with the corresponding reference transmission power to pico eNB. The serving cell eNB (for example the pico eNB) provides the pico UE (that is the victim UE) with the corresponding subframe subset information and the corresponding reference transmission power related to a certain cell ID via higher layer signaling, such as through dedicated RRC signaling. This allows the pico UE to distinguish between which subframe to do the appropriate CRS interference cancellation from different dominant interfering sources. Both the differentiated flexible subframe subset and the fixed subframe subset belong to the ABS.

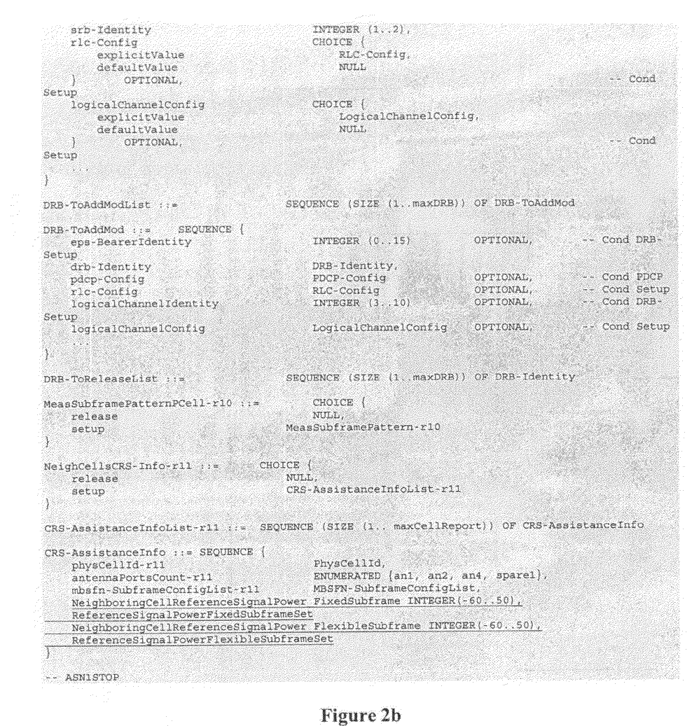

Exemplary embodiments described above can be seen in the combination of FIG. 2a and FIG. 2b which is known as a RadioResourceConfigDedicated information element. The underlined portion of FIG. 2b represents a non-limiting exemplary embodiment of this invention which is added to the conventional information element. The RadioResourceConfigDedicated information element is used to setup, modify, and release resource blocks, to modify the medium access control (MAC) main configuration, to modify the semi-persistent scheduling (SPS) configuration and to modify the dedicated physical configuration. As adapted according to these teachings it is also used to inform of the neighboring cell reference signal transmission power and also of which subframes are fixed and which are flexible.

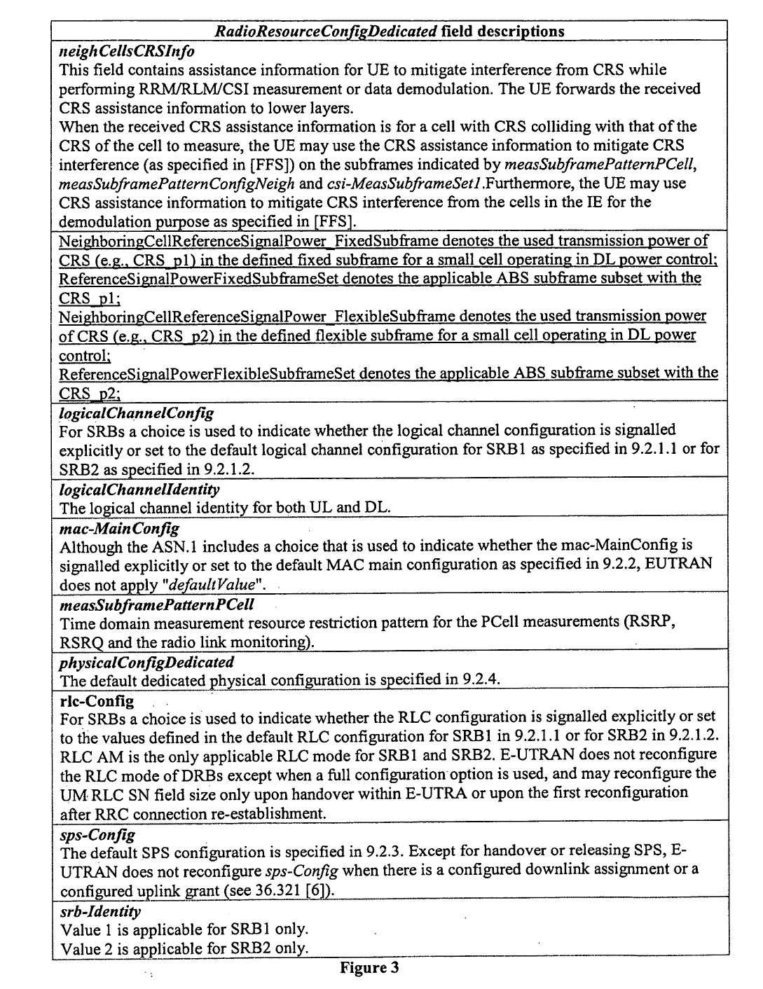

FIG. 3 is a chart which provides RadioResourceConfigDedicated field descriptions of some of the terms used in FIG. 2a and FIG. 2b. The underlined portion of FIG. 3 corresponds to the terms used in the underlined portion of FIG. 2b.

The impact of small cell power control has not been previously considered for different scenarios when performing CRS interference cancellation, especially when flexible TDD between cells is enabled. The exemplary embodiments detailed herein, which may use assistance information for CRS interference cancellation, can effectively deal with the problem of unprompted CRS interference cancellation in measurements by taking into account the impact of flexible TDD and small cell DL power control.

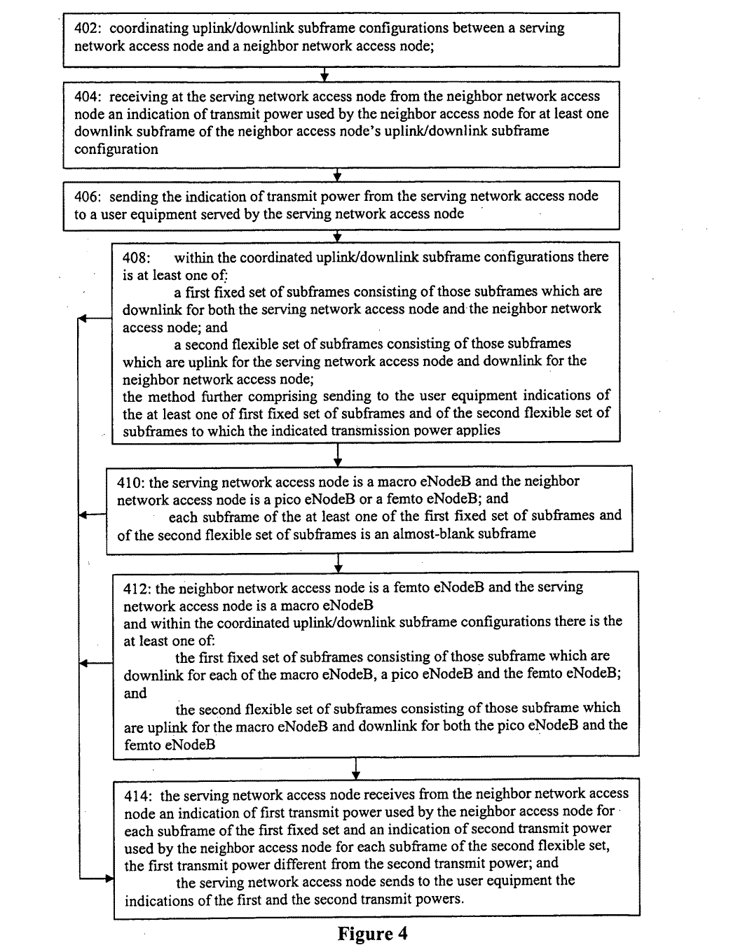

FIG. 4 presents a summary of the above teachings for operating a network access node such as for example one capable of operating in a LTE or LTE-Advanced (LTE-A) network. FIG. 4 is from the perspective of a network access node such as an eNB, and in some embodiments it may be in the position of the UE's serving macro cell and in other embodiments it may be in the position of a pico cell between the macro cell and a femto cell. At block 402 the network access node is coordinating uplink/downlink subframe configurations between a serving network access node and a neighbor network access node. At block 404 the access node is receiving at the serving network access node from the neighbor network access node an indication of transmit power used by the neighbor access node for at least one downlink subframe of the neighbor access node's uplink/downlink subframe configuration. At block 406 the access node is sending the indication of transmit power from the serving network access node to a user equipment served by the serving network access node.

Non-limiting exemplary embodiments of these teachings can also continue at block 408 which specifies that within the coordinated uplink/downlink subframe configurations there is at least one of: a first fixed set of subframes consisting of those subframes which are downlink for both the serving network access node and the neighbor network access node; and a second flexible set of subframes consisting of those subframes which are uplink for the serving network access node and downlink for the neighbor network access node; the method further comprising sending to the user equipment indications of the at least one of the first fixed set of subframes and of the second flexible set of subframes to which the indicated transmission power applies.

Block 410 specifies that the serving network access node is a macro eNodeB and the neighbor network access node is a pico eNodeB or a femto eNodeB; and each subframe of the at least one of the first fixed set of subframes and of the second flexible set of subframes is an almost-blank subframe. The pico eNodeB and the femto eNodeB are merely examples of small cell eNodeBs suitable for performing exemplary embodiments of this invention.

Block 412 of FIG. 4 specifies the neighbor network access node is a femto eNodeB and the serving network access node is a macro eNodeB and within the coordinated uplink/downlink subframe configurations there is the at least one: the first fixed set of subframes consisting of those subframe which are downlink for each of the macro eNodeB, a pico eNodeB and the femto eNodeB; and the second flexible set of subframes consisting of those subframe which are uplink for the macro eNodeB and downlink for both the pico eNodeB and the femto eNodeB. Additionally, coordination of subframe configurations based on the uplink/downlink relationship between the serving network access node and the neighbor access node is a non-limiting exemplary embodiment of these teachings. Exemplary embodiments of these teachings are also applicable more generally for other instances where the subframes are classified by a different rule. The serving network access node could send to the user equipment an indication of a set of subframes for which interference seen by the UE is similar given the transmit power used by the neighbor access node and the transmit power used by the serving network access node. Similar in this instance refers to a category or type of interference rather than a specific level.

Block 414 states that the serving network access node receives from the neighbor network access node an indication of first transmit power used by the neighbor access node for each subframe of the first fixed set and an indication of second transmit power used by the neighbor access node for each subframe of the second flexible set, the first transmit power different from the second transmit power; and the serving network access node sends to the user equipment the indications of the first and the second transmit powers.

Non-limiting exemplary embodiments of these teachings can also include the indication of transmit power used by the neighbor access node and the indications of the first fixed set of subframes and of the second flexible set of subframes are sent to the user equipment in a RadioResourceConfigDedicated information element. These teachings can also include that each of the at least one downlink subframe of the neighbor access node's uplink/downlink subframe configuration for which the transmit power is indicated is an almost blank subframe (ABS).

The logic diagram of FIG. 4 may be considered to illustrate the operation of a method, and a result of execution of a computer program stored in a computer readable memory, and a specific manner in which components of an electronic device are configured to cause that electronic device to operate, whether such an electronic device is a network access node or some other portable electronic device, or one or more components thereof such as a modem, chipset, or the like. The various blocks shown in FIG. 4 may also be considered as a plurality of coupled logic circuit elements constructed to carry out the associated function(s), or specific result of strings of computer program code or instructions stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Such circuit/circuitry embodiments include any of the following: (a) hardware-only circuit implementations (such as implementations in only analog and/or digital circuitry) and (b) combinations of circuits and software (and/or firmware), such as: (i) a combination of processor(s) or (ii) portions of processor(s)/software (including digital signal processor(s)), software, and memory(ies) that work together to cause an apparatus, such as a network access node, to perform the various functions summarized at FIG. 4 and (c) circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” also covers, for example, a baseband integrated circuit or applications processor integrated circuit for a user equipment UE or for a network access node/eNB or a similar integrated circuit in a server or other network device which operates according to these teachings.

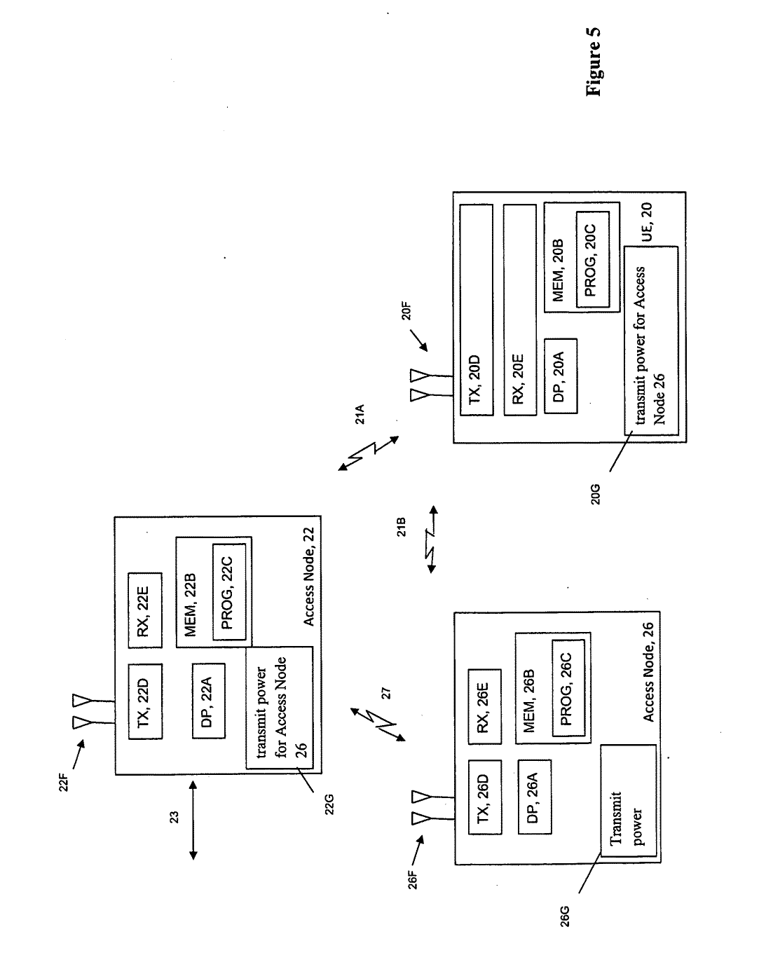

Reference is now made to FIG. 5 for illustrating a simplified block diagram of various electronic devices and apparatus that are suitable for use in practicing the exemplary embodiments of this invention. In FIG. 5, an Access Node 22 is adapted for communication over a wireless link 21A with an apparatus, such as a mobile terminal or UE 20. The Access Node 22 may be any access node such as a node-B or an enhanced-node-B (including frequency selective repeaters) of any wireless network using licensed bands, such as LTE.

The UE 20 is operating in a cell wherein Access Node 22 is the serving cell. UE 20 includes processing means such as at least one data processor (DP) 20A, storing means such as at least one computer-readable memory (MEM) 20B storing at least one computer program (PROG) 20C, first communication means such as a transmitter TX 20D and a receiver RX 20E for bidirectional wireless communications with the Access Node 22 or Access Node 26 on a RAT. All of these wireless communications are via one or more antennas 20F. UE 20 is also operable to receive and store the reference signal transmit power of neighbor cell Access Node 26 in 20G for performing embodiments of this invention.

The Access Node 22 also includes processing means such as at least one data processor (DP) 22A, storing means such as at least one computer-readable memory (MEM) 22B storing at least one computer program (PROG) 22C, and communication means such as a transmitter TX 22D and a receiver RX 22E for bidirectional wireless communications with the UE 20 on a RAT via one or more antennas 22F. Access Node 22 is also operable such that it can receive, store and transmit the transmit power for Access Node 26 in 22G in accordance with exemplary embodiments of this invention.

Also in FIG. 5 is Access Node 26 operating in a cell different from Access Node 22. The Access Node 26 includes processing means such as at least one data processor (DP) 26A, storing means such as at least one computer-readable memory (MEM) 26B storing at least one computer program (PROG) 26C, and communication means such as a transmitter TX 26D and a receiver RX 26E for bidirectional wireless communications with the UE 20 on a radio access technology via one or more antennas 26F. Access Node 26 is also operable such that it can store its transmit power 26G for transmitting same in accordance with exemplary embodiments of these teachings.

While not particularly illustrated for the UE 20 or either of the Access Node 22 or Access Node 26, those devices are also assumed to include as part of their wireless communicating means a modem and/or a chipset which may or may not be inbuilt onto an RF front end chip within those devices 20, 22, and 26 and which also operates according to the radio access technologies set forth above.

At least one of the PROGs 20C in the UE 20 is assumed to include a set of program instructions that, when executed by the associated DP 20A, enable the device to operate in accordance with the exemplary embodiments of this invention, as detailed above. The Access Node 22 also has software stored in its MEM 22B to implement certain aspects of these teachings. Further, the Access Node 26 may also have implementing software to put into effect the teachings herein as detailed above. In these regards the exemplary embodiments of this invention may be implemented at least in part by computer software stored on the MEM 20B, 22B, and 26B which is executable by the DP 20A of the UE 20 and/or by the DP 22A of the Access Node 22, and/or by the DP 26A of the Access Node 26; or by hardware, or by a combination of tangibly stored software and hardware (and tangibly stored firmware) in any one or more of these devices 20, 22, 26. Electronic devices implementing these aspects of the invention need not be the entire devices as depicted at FIG. 5 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular and other mobile phones, navigation devices, laptop/palmtop/tablet computers, digital cameras and music devices, and Internet appliances.

Various embodiments of the computer readable MEMs 20B, 22B, 26B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A, 26A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE/LTE-A (or UTRAN) systems, as noted above the exemplary embodiments of this invention are not limited for use with only these particular types of wireless radio access technology networks.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. A method for operating a network access node, the method comprising:
coordinating uplink/downlink subframe configurations between a serving network access node and a neighbor network access node;
receiving at the serving network access node from the neighbor network access node an indication of transmit power used by the neighbor access node for at least one downlink subframe of the neighbor access node's uplink/downlink subframe configuration; and
sending the indication of transmit power from the serving network access node to a user equipment served by the serving network access node.

2. The method according to claim 1, wherein within the coordinated uplink/downlink subframe configurations there is at least one of:
a first fixed set of subframes consisting of those subframes which are downlink for both the serving network access node and the neighbor network access node; and
a second flexible set of subframes consisting of those subframes which are uplink for the serving network access node and downlink for the neighbor network access node;
the method further comprising sending to the user equipment indications of the at least one of the first fixed set of subframes and of the second flexible set of subframes to which the indicated transmission power applies.

3. The method according to claim 2, wherein:
the serving network access node is a macro eNodeB and the neighbor network access node is a pico eNodeB or a femto eNodeB; and
each subframe of the at least one of the first fixed set of subframes and of the second flexible set of subframes is an almost-blank subframe.

4. The method according to claim 3, wherein:
the neighbor network access node is a femto eNodeB and the serving network access node is a macro eNodeB
and within the coordinated uplink/downlink subframe configurations there is the at least one of:
the first fixed set of subframes consisting of those subframe which are downlink for each of the macro eNodeB, a pico eNodeB and the femto eNodeB; and
the second flexible set of subframes consisting of those subframe which are uplink for the macro eNodeB and downlink for both the pico eNodeB and the femto eNodeB.

5. The method according to claim 2, wherein:
the serving network access node receives from the neighbor network access node an indication of first transmit power used by the neighbor access node for each subframe of the first fixed set and an indication of second transmit power used by the neighbor access node for each subframe of the second flexible set, the first transmit power different from the second transmit power; and
the serving network access node sends to the user equipment the indications of the first and the second transmit powers.

6. The method according to claim 2, wherein the indication of transmit power used by the neighbor access node and the indications of the first fixed set of subframes and of the second flexible set of subframes are sent to the user equipment in a RadioResourceConfigDedicated information element.

7. The method according to claim 1, the method further comprising sending to the user equipment an indication of a set of subframes for which interference seen by the UE is similar given the transmit power used by the neighbor access node and the transmit power used by the serving network access node.

8. The method according claim 1, wherein each of the at least one downlink subframe of the neighbor access node's uplink/downlink subframe configuration for which the transmit power is indicated is an almost blank subframe (ABS).

9. An apparatus, the apparatus comprising:
at least one processor configured to
coordinate uplink/downlink subframe configurations between a serving network access node and a neighbor network access node;
receive at the serving network access node from the neighbor network access node an indication of transmit power used by the neighbor access node for at least one downlink subframe of the neighbor access node's uplink/downlink subframe configuration; and
send the indication of transmit power from the serving network access node to a user equipment served by the serving network access node.

10. The apparatus according to claim 9, wherein within the coordinated uplink/downlink subframe configurations there is at least one of:
a first fixed set of subframes consisting of those subframes which are downlink for both the serving network access node and the neighbor network access node; and
a second flexible set of subframes consisting of those subframes which are uplink for the serving network access node and downlink for the neighbor network access node;
the at least one processor, with the at least one memory and the computer program code, being further configured to cause the apparatus at least to send to the user equipment indications of the at least one of the first fixed set of subframes and of the second flexible set of subframes to which the indicated transmission power applies.

11. The apparatus according to claim 10, wherein:
the serving network access node is a macro eNodeB and the neighbor network access node is a pico eNodeB or a femto eNodeB; and
each subframe of the at least one of the first fixed set of subframes and of the second flexible set of subframes is an almost-blank subframe.

12. The apparatus according to claim 11, wherein:
the neighbor network access node is a femto eNodeB and the serving network access node is a macro eNodeB
and within the coordinated uplink/downlink subframe configurations there is the at least one of:
the first fixed set of subframes consisting of those subframe which are downlink for each of the macro eNodeB, a pico eNodeB and the femto eNodeB; and
the second flexible set of subframes consisting of those subframe which are uplink for the macro eNodeB and downlink for both the pico eNodeB and the femto eNodeB.

13. The apparatus according to claim 10, wherein:
the serving network access node receives from the neighbor network access node an indication of first transmit power used by the neighbor access node for each subframe of the first fixed set and an indication of second transmit power used by the neighbor access node for each subframe of the second flexible set, the first transmit power different from the second transmit power; and
the serving network access node sends to the user equipment the indications of the first and the second transmit powers.

14. The apparatus according to claim 10, wherein the indication of transmit power used by the neighbor access node and the indications of the first fixed set of subframes and of the second flexible set of subframes are sent to the user equipment in a RadioResourceConfigDedicated information element.

15. The apparatus according to claim 10, wherein the at least one processor, with the at least one memory and the computer program code, being configured to cause the apparatus at least to send to the user equipment an indication of a set of subframes for which interference seen by the UE is similar given the transmit power used by the neighbor access node and the transmit power used by the serving network access node.

16. The apparatus according to claim 9, wherein each of the at least one downlink subframe of the neighbor access node's uplink/downlink subframe configuration for which the transmit power is indicated is an almost blank subframe (ABS).

17. A non-transitory computer readable memory tangibly storing a set of computer instructions comprising code, which, when executed on a data processing system, causes the data processing system to at least:
coordinate uplink/downlink subframe configurations between a serving network access node and a neighbor network access node;
receive at the serving network access node from the neighbor network access node an indication of transmit power used by the neighbor access node for at least one downlink subframe of the neighbor access node's uplink/downlink subframe configuration; and
send the indication of transmit power from the serving network access node to a user equipment served by the serving network access node.

18. The computer readable memory according to claim 17, wherein within the coordinated uplink/downlink subframe configurations there is at least one of:
a first fixed set of subframes consisting of those subframes which are downlink for both the serving network access node and the neighbor network access node; and
a second flexible set of subframes consisting of those subframes which are uplink for the serving network access node and downlink for the neighbor network access node;
the set of computer instructions comprising code, which, when executed on a data processing system, further causes the data processing system to at least send to the user equipment indications of the at least one of the first fixed set of subframes and of the second flexible set of subframes to which the indicated transmission power applies.

19. The computer readable memory according to claim 18, wherein:
the serving network access node is a macro eNodeB and the neighbor network node is a pico eNodeB or a femto eNodeB; and
each subframe of the at least one of the first fixed set of subframes and of the second flexible set of subframes is an almost-blank subframe.

20. The computer readable memory according to claim 19, wherein:
the neighbor network access node is a femto eNodeB and the serving network access node is a macro eNodeB
and within the coordinated uplink/downlink subframe configurations there is the at least one of:
the first fixed set of subframes consisting of those subframe which are downlink for each of the macro eNodeB, a pico eNodeB and the femto eNodeB; and
the second flexible set of subframes consisting of those subframe which are uplink for the macro eNodeB and downlink for both the pico eNodeB and the femto eNodeB.

21-24. (canceled)
